(19) United States
(12) Patent Application Publication
(10) Pub. No.: US 2025/0256313 A1
(43) Pub. Date: Aug. 14, 2025

(54) METHOD FOR DISPOSING OF BATTERY AND COVERING BODY

(71) Applicant: TOYOTA JIDOSHA KABUSHIKI KAISHA, Toyota-shi (JP)

(72) Inventors: Fuminori MIZUNO, Miyoshi-shi (JP); Hiroshi SUYAMA, Mishima-shi (JP); Taketo MIZUNO, Toyota-shi (JP); Yuki OGURA, Anjo-shi (JP); Kunimitsu YAMAMOTO, Kasugai-shi (JP)

(73) Assignee: TOYOTA JIDOSHA KABUSHIKI KAISHA, Toyota-shi (JP)

(21) Appl. No.: 19/043,759

(22) Filed: Feb. 3, 2025

(30) Foreign Application Priority Data
Feb. 13, 2024 (JP) 2024-019451

(51) Int. Cl. B09B 5/00; B09B 101/16; H01M 4/46; H01M 10/54

(52) U.S. Cl. CPC B09B 5/00; H01M 4/463; B09B 2101/16; H01M 10/54

(57) ABSTRACT

A main object of the present disclosure is to provide a method for disposing of a battery, with which the battery can be deactivated well. The present disclosure achieves the object by providing a method for disposing of a battery, the method including: a soaking step of soaking a battery including an Al terminal in a treatment liquid to decrease a voltage of the battery by causing outer short circuit through the treatment liquid, wherein the treatment liquid contains water and a supporting salt; and in the soaking step, a covering body including conductivity is used, and the covering body is arranged so as to cover at least a part of the Al terminal to make the treatment liquid and the Al terminal electrically connected through the covering body.

### TECHNICAL FIELD

The present disclosure relates to a method for disposing of a battery and a covering body.

### BACKGROUND ART

A battery usually includes a terminal configured to take out electricity from an electrode body that is a power generating element. For example, Patent Literature 1 discloses a battery module that includes a laminate flat exterior battery including a cathode terminal lead and an anode terminal lead, wherein the cathode terminal lead is made of aluminum.

### CITATION LIST

### Patent Literature

Patent Literature 1: Japanese Patent Application Laid-Open (JP-A) No. 2007-257849

### SUMMARY OF DISCLOSURE

### Technical Problem

Upon recycling a battery, it is desired to decrease the remaining voltage of the battery and deactivate the battery. Examples of the method for deactivating the battery may include a method in which the battery is soaked in a treatment liquid (such as salt water) to cause outer short circuit. In a case of the battery including an aluminum terminal (Al terminal), it may be difficult to deactivate the battery well since the Al terminal is deteriorated by the treatment liquid.

The present disclosure has been made in view of the above circumstances, and a main object thereof is to provide a method for disposing of a battery, with which the battery can be deactivated well.

### Solution to Problem

[1]

A method for disposing of a battery, the method comprising:
a soaking step of soaking a battery including an Al terminal in a treatment liquid to decrease a voltage of the battery by causing outer short circuit through the treatment liquid, wherein
the treatment liquid contains water and a supporting salt; and
in the soaking step, a covering body including conductivity is used, and the covering body is arranged so as to cover at least a part of the Al terminal to make the treatment liquid and the Al terminal electrically connected through the covering body.
[2]

The method for disposing of a battery according to [1], wherein
the covering body includes a conductive member; and
in the soaking step, the covering body is arranged on the Al terminal so as to electrically connect the conductive member and the Al terminal.
[3]

The method for disposing of a battery according to [2], wherein the conductive member is a metal member.
[4]

The method for disposing of a battery according to [3], wherein a material of the metal member is an aluminum or an aluminum alloy.
[5]

The method for disposing of a battery according to [3], wherein a material of the metal member is an iron or an iron alloy.
[6]

The method for disposing of a battery according to [3], wherein a material of the metal member is a magnesium, a magnesium alloy, a zinc, or a zinc alloy.
[7]

The method for disposing of a battery according to any one of [3] to [6], wherein the metal member includes a conductive resin part on the Al terminal side surface.
[8]

The method for disposing of a battery according to any one of [3] to [6], wherein the metal member includes a plated part on the Al terminal side surface.
[9]

The method for disposing of a battery according to any one of [2] to [8], wherein
the covering body further includes a first member, a second member, and a connecting member configured to connect the first member and the second member; and
in the soaking step, the first member and the second member are faced to each other interposing the Al terminal, and a relative position of the first member and the second member is fixed by the connecting member, so that the covering body is arranged on the Al terminal, and the conductive member is arranged between the first member and the Al terminal.
[10]

The method for disposing of a battery according to [1], wherein
the covering body includes a first member, a second member, and a connecting member configured to connect the first member and the second member;
at least one of the first member and the second member is a conductive member; and
in the soaking step, the first member and the second member are faced to each other interposing the Al terminal, and a relative position of the first member and the second member is fixed by the connecting member, so that the covering body is arranged on the Al terminal.
[11]

The method for disposing of a battery according to [1], wherein
the covering body is a hollow member including a space part;
the hollow member is a conductive member; and
in the soaking step, the Al terminal is inserted to the space part so as to arrange the covering body on the Al terminal.
[12]

The method for disposing of a battery according to [1], wherein
the covering body includes a first member, and a pair of nail member arranged in each of a pair of side of the first member facing to each other;
at least one of the first member and the nail member is a conductive member; and
in the soaking step, the Al terminal is fixed by the pair of nail member so that the covering body is arranged on the Al terminal.
[13]

The method for disposing of a battery according to any one of [1] to [12], wherein
the battery includes an electrode body, an outer package covering the electrode body, and the Al terminal that is electrically connected to the electrode body, and is partially exposed from the outer package; and
in the soaking step, the covering body is arranged so as to cover at least a boundary of the Al terminal and the outer package.
[14]

The method for disposing of a battery according to any one of [1] to [13], wherein the battery includes a laminate type outer package.
[15]

The method for disposing of a battery according to any one of [1] to [14], wherein the battery is a solid state battery.
[16]

A covering body to be used for the method for disposing of a battery according to any one of [1] to [15], wherein
the covering body corresponds to any one of (i) to (iv) as follows:
(i) the covering body includes a conductive member;
(ii) the covering body includes a first member, a second member, and a connecting member configured to connect the first member and the second member, and at least one of the first member and the second member is a conductive member;
(iii) the covering body is a hollow member including a space part, and the hollow member is a conductive member;
(iv) the covering body includes a first member, and a pair of nail member arranged in each of a pair of side of the first member facing to each other, and at least one of the first member and the nail member is a conductive member.

### Advantageous Effects of Disclosure

The present disclosure exhibits an effect of deactivating a battery well.

### BRIEF DESCRIPTION OF DRAWINGS

FIG. 1A is a schematic plane view and FIG. 1B is a schematic side view exemplifying the battery in the present disclosure.

FIG. 2 is a schematic side view exemplifying the method for disposing of a battery in the present disclosure.

FIGS. 3A and 3C are schematic plane views and FIGS. 3B and 3D are schematic cross-sectional views exemplifying a part of the battery and the covering body in the present disclosure.

FIG. 4A is a schematic perspective view and FIG. 4B is a schematic side view exemplifying the covering body in the present disclosure.

FIG. 5A is a schematic perspective view and FIG. 5B is a schematic side view exemplifying the covering body in the present disclosure.

FIG. 6 is a schematic perspective view exemplifying the covering body in the present disclosure.

FIG. 7 is a schematic perspective view exemplifying the covering body in the present disclosure.

FIG. 8 is a schematic perspective view exemplifying the covering body in the present disclosure.

FIG. 9 is a schematic perspective view exemplifying the covering body in the present disclosure.

FIGS. 10A and 10B are schematic plan views exemplifying the position of the covering body in the present disclosure.

FIGS. 11A and 11B are schematic cross-sectional views exemplifying the electrode body in the present disclosure.

FIG. 12 is a graph showing the results of a soaking test in Comparative Example.

FIG. 13 is a graph showing the results of a soaking test in Example.

### DESCRIPTION OF EMBODIMENTS

The method for disposing of a battery and the covering body in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

### A. Method for Disposing of Battery

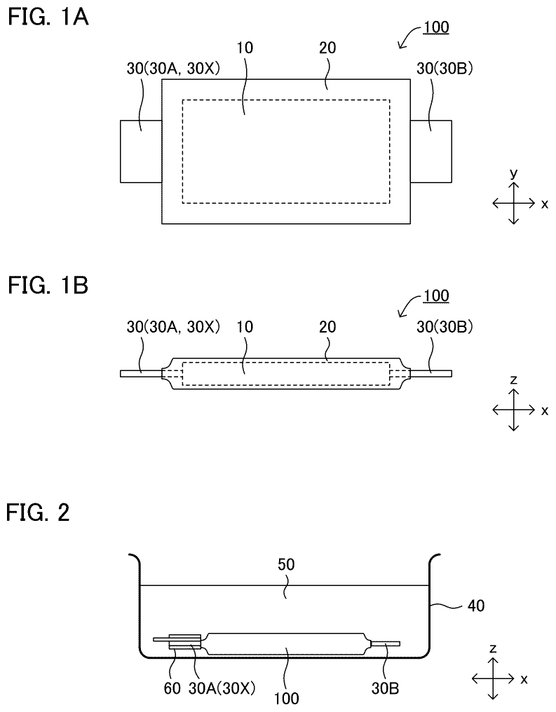

FIG. 1A is a schematic plane view and FIG. 1B is a schematic side view exemplifying the battery in the present disclosure. As shown in FIGS. 1A and 1B, battery 100 includes electrode body 10, outer package 20 covering the electrode body 10, and terminal 30 (30A, 30B) that is electrically connected to the electrode body 10 and is partially exposed from the outer package 20. At least one of the terminal 30A and the terminal 30B is an Al terminal. In FIGS. 1A and 1B, the terminal 30A corresponds to Al terminal 30X.

FIG. 2 is a schematic side view exemplifying the method for disposing of a battery in the present disclosure. As shown in FIG. 2, treatment liquid 50 is put in treating bath 40, and the battery 100 is soaked in the treatment liquid 50. The terminal 30A and the terminal 30B are conducted through the treatment liquid 50 to cause outer short circuit, and thereby the voltage of the battery 100 is decreased. In the present disclosure, covering body 60 including conductivity is used, and the covering body 60 is arranged so as to cover at least a part of the Al terminal 30X. Thereby, the treatment liquid 50 and the Al terminal 30X are electrically connected through the covering body 60.

According to the present disclosure, since the covering body including conductivity is arranged to cover the Al terminal, the battery can be deactivated well. As described above, upon recycling a battery, it is desired to decrease the remaining voltage of the battery to deactivate the battery. By deactivating the battery, later steps such as a battery disassembling step can be safely performed. Examples of the method for deactivating the battery may include a method in which the battery is soaked in a treatment liquid (such as salt water) to cause outer short circuit. In a case of the battery including an Al terminal, the Al terminal is deteriorated by the treatment liquid, and it may be difficult to deactivate the battery well. For example, corrosion (elution) of the Al terminal is caused by the treatment liquid, and when the Al terminal exposed from the outer package slips, the decrease in the remaining voltage due to outer short circuit may not be caused or the decrease speed may be significantly slowed down.

In contrast, in the present disclosure, the covering body including conductivity is arranged to cover the Al terminal. Thereby, the deterioration of the Al terminal by the treatment liquid can be inhibited. For this reason, the outer short circuit can be maintained when the battery is soaked in the treatment liquid, and the battery can be deactivated well.

The method for disposing of a battery in the present disclosure includes a soaking step of soaking a battery including an Al terminal in a treatment liquid to decrease a voltage of the battery by causing outer short circuit through the treatment liquid. Further, in the present disclosure, a covering body including conductivity is used, and the covering body is arranged so as to cover at least a part of the Al terminal to make the treatment liquid and the Al terminal electrically connected through the covering body. Incidentally, in the method for disposing of a battery in the present disclosure, it is not necessary to completely prevent the deterioration of the Al terminal, but the deterioration of the Al terminal may be inhibited by the covering body to the extent the battery can be deactivated well.

### 1. Covering Body

The covering body in the present disclosure includes conductivity. Also, the covering body is electrically connected to the Al terminal. The covering body is, to the main surface of the Al terminal, preferably directly in surface-contact, or in surface-contact interposing another layer. When the covering body is in surface-contact with the main surface of the Al terminal, the main surface of the Al terminal is protected by the covering body. Among the main surface of the Al terminal, in a region protected by the covering body, contact with the treatment liquid is inhibited, and the deterioration of the Al terminal is inhibited. The covering body in the present disclosure will be hereinafter explained in four separate aspects.

### (1) First Aspect

The covering body in the first aspect includes a conductive member. Also, in the soaking step, the covering body is arranged on the Al terminal so as to electrically connect the conductive member and the Al terminal.

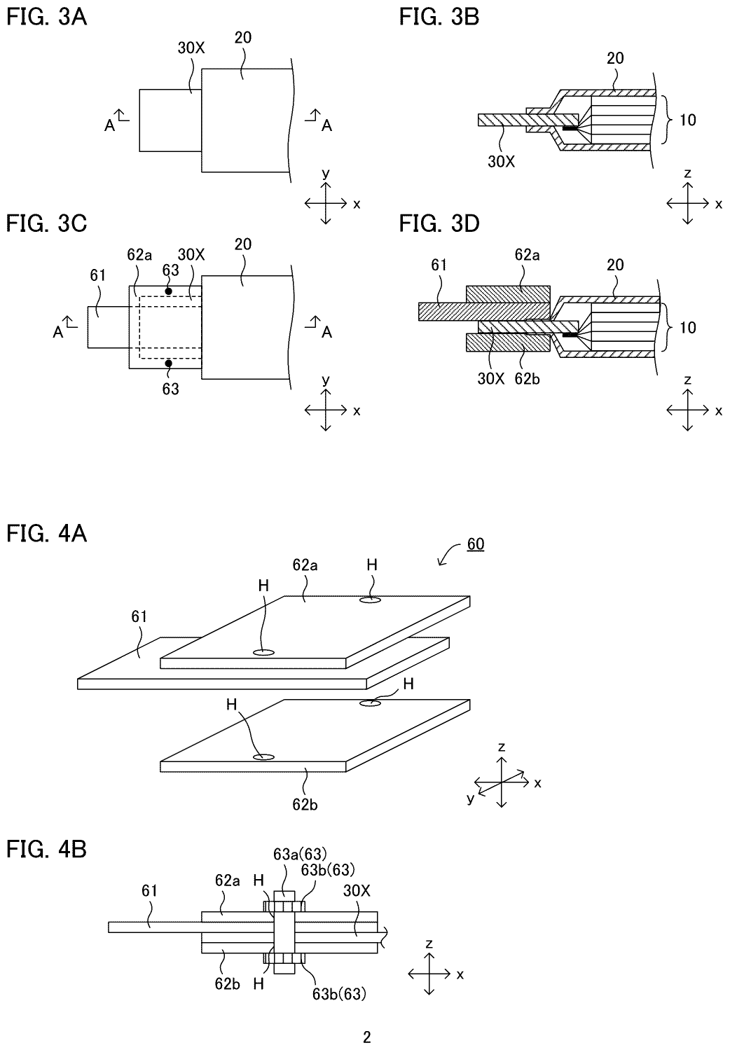

Here, FIG. 3A is a schematic plan view exemplifying a part of the battery (before arranging the covering body) in the present disclosure, and FIG. 3B is a cross-sectional view of A-A in FIG. 3A. FIG. 3C is a schematic plan view exemplifying a part of the battery (after arranging the covering body) in the present disclosure, and FIG. 3D is a cross-sectional view of A-A in FIG. 3C. Also, FIG. 4A is a schematic perspective view exemplifying the covering body in the present disclosure, and FIG. 4B is a schematic side view exemplifying the covering body in the present disclosure. Incidentally, for convenience, the description of the connecting member is omitted in FIG. 4A.

As shown in FIGS. 3A and 3B, the Al terminal 30X is electrically connected to the electrode body 10, and partially exposed from the outer package 20. Meanwhile, the covering body 60 shown in FIGS. 4A and 4B includes conductive member 61, and further includes first member 62a, second member 62b, and connecting member 63. As shown in FIGS. 3C and 3D, a covering body (conductive member 61) is arranged on the Al terminal 30X so that the conductive member 61 and the Al terminal 30X are electrically connected. Also, as shown in FIG. 3C, when observed from the thickness direction (front and back direction of paper), the conductive member 61 may be arranged to overlap the Al terminal 30X partially. Meanwhile, although not illustrated in particular, when observed from the thickness direction, the conductive member may be arranged to cover the Al terminal entirely.

As shown in FIGS. 4A and 4B, the covering body 60 in the first aspect includes conductive member 61. The conductive member is electrically connected to the Al terminal in the soaking step. In the soaking step, the conductive member is, to the main surface of the Al terminal, preferably directly in surface-contact, or in surface-contact interposing another layer. When the conductive member is in surface-contact with the main surface of the Al terminal, the main surface of the Al terminal is protected by the conductive member. Among the main surface of the Al terminal, in the region protected by the conductive member, the contact with the treatment liquid is inhibited, and the deterioration of the Al terminal is inhibited. In particular, in a case the conductive member is not easily deteriorated by the treatment liquid compared to the Al terminal, the outer short circuit can be maintained while inhibiting the deterioration of the Al terminal, and thus the battery can be deactivated well.

Examples of the conductive material may include a metal member and a carbon member, and the metal member is preferable. Examples of the metal member may include aluminum and an aluminum alloy. The aluminum alloy is an alloy containing aluminum as a main component of the metal component. In the aluminum alloy, the proportion of the aluminum with respect to all the metal components is, for example, 50 weight % or more, may be 70 weight % or more, and may be 90 weight % or more.

The material of the metal member may be a material with lower ionizing tendency (material which natural potential is noble) than that of the Al terminal. The material with lower ionizing tendency than that of the Al terminal has high resistance to the treatment liquid. Examples of such a material may include iron, an iron alloy, titanium, a titanium alloy, copper, a copper alloy, a lead and a lead alloy, and among those, the iron alloy is preferable, and in particular, stainless steel is preferable. Meanwhile, when the material of the metal member is a material with lower ionizing tendency than that of the Al terminal, if the treatment liquid is present between the metal member and the Al terminal, corrosion (galvanic corrosion) of the Al terminal easily occurs. For this reason, in the soaking step, it is preferable to closely adhere the metal member and the Al terminal so that the treatment liquid does not enter between the metal member and the Al terminal. Alternatively, the metal member preferably includes the later described conductive resin part or plated part on the Al terminal side surface. Incidentally, in the method for disposing of a battery in the present disclosure, it is not necessary to completely prevent the corrosion of the Al terminal, but the corrosion of the Al terminal may be inhibited by the conductive member to the extent the battery can be deactivated well.

The material of the metal member may be a material of which ionizing tendency is equivalent to that of the Al terminal, or a material with higher ionizing tendency (material of which natural potential is base) than that of the Al terminal. Examples of such a material may include magnesium, a magnesium alloy, zinc, and a zinc alloy. When such a material is used, corrosion of the Al terminal does not easily occur even when the treatment liquid is present between the metal member and the Al terminal. Meanwhile, since the corrosion of the metal member proceeds, for example, it is preferable to set the thickness of the metal member be sufficiently large. Also, the metal member may be an Al-containing member including Al as a main component.

The shape of the conductive member is not particularly limited, but for example it is a flat plate shape. Also, the thickness of the conductive member is not particularly limited, but it is preferably larger than the thickness of the Al terminal. The ratio of the thickness of the conductive member with respect to the thickness of the Al terminal is, for example, 1.2 times or more, may be 1.5 times or more, may be 2 times or more, and may be 5 times or more. Meanwhile, the ratio is not particularly limited, but for example, it is 20 times or less and may be 15 times or less.

When the conductive member is the metal member, the metal member may include a conductive resin part on the Al terminal side surface. By arranging the conductive resin part, for example, corrosion of the Al terminal can be inhibited even when the material of the metal member is a material with lower ionizing tendency than that of the Al terminal.

The conductive resin part includes, for example, a resin (including rubber) and a conductor. Examples of the resin may include a polyolefine-based resin such as polyethylene, polypropylene, and polystyrene; an imide-based resin such as polyimide and polyamideimide; an amide-based resin such as polyamide; an acrylic-based resin such as polymethylacrylate, polyethylacrylate, polypropylacrylate, polybutylacrylate, polyhexylacrylate, poly2-ethylhexylacrylate, polydecylacrylate, and polyacrylate; a methacrylate-based resin such as polymethylmethacrylate, polyethylmethacrylate, polybutylmethacrylate, poly2-ethylhexylmethacrylate, and polymethacrylate; a polycarbonate-based resin such as polyitaconic acid, polycrotonic acid, polyfumaric acid, polyangelic acid, and carboxymethylcellulose; a fluorine-based resin such as polyvinylydene fluoride (PVDF), a polyvinylydene-polyhexafluoro polypropylene copolymer (PVDF-HFP), and polytetra fluoro ethylene; and a rubber such as a butadiene rubber, a hydride butadiene rubber, a styrene butadiene rubber (SBR), a hydride styrene butadiene rubber, a nitrile butadiene rubber, a hydride nitrile butadiene rubber, an ethylene propylene rubber and a fluorine rubber. Meanwhile, examples of the conductor may include a carbon material, a metal particle, and a conductive polymer. Examples of the carbon material may include a particulate carbon material such as acetylene black (AB) and Ketjen black (KB), and a fiber carbon material such as carbon fiber, carbon nanotube (CNT), and carbon nanofiber (CNF). Examples of the method for forming the conductive resin part may include a method in which a slurry containing a resin, a conductor and a solvent is applied on the metal member and dried.

When the conductive member is the metal member, the metal member may include a plated part on the Al terminal side surface. By arranging the plated part, the close adhesion of the conductive member and the Al terminal improves. The material of the plated part is not particularly limited, but examples thereof may include a material with lower ionizing tendency than that of the Al terminal. Examples of such a material may include gold, silver, and palladium. Examples of the method for forming the plated part may include an electrolyte plating method and a non-electrolyte plating method.

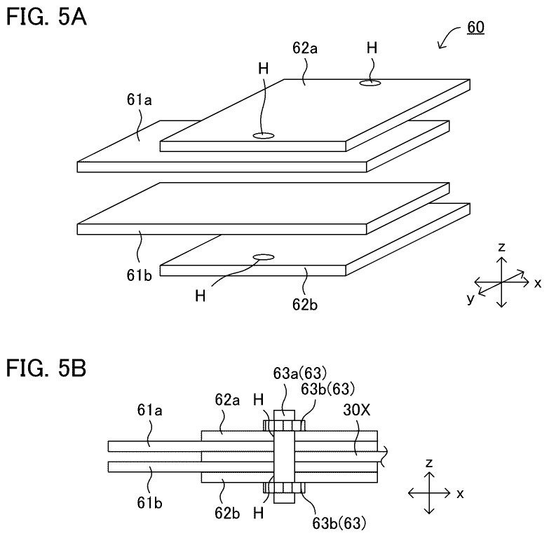

In the first aspect, there are no particular limitations on the method for fixing the conductive member on the Al terminal, and it may be fixed by an arbitrary method. For example, the conductive member may be fixed on the Al terminal by sandwiching the conductive material and the Al terminal by a clip. Also, for example, as shown in FIGS. 4A and 4B, the covering body 60 in the first aspect may include first member 62a, second member 62b, and connecting member 63, in addition to the conductive member 61. As shown in FIGS. 3C and 3D, the first member 62a and the second member 62b are faced to each other interposing the Al terminal 30X, and a relative position of the first member 62a and the second member 62b is fixed by the connecting member 63, and thereby the covering body 60 is arranged on the Al terminal 30X. Also, the conductive member 61 is arranged between the first member 62a and the Al terminal 30X. Also, in FIGS. 4A and 4B, the conductive member 61 is arranged on one surface of the Al terminal 30X. Meanwhile, as shown in FIGS. 5A and 5B, the conductive member 61a and the conductive member 61b may be respectively arranged on both surfaces of the Al terminal 30X.

At least one of the first member and the second member may be a conductive member. The conductive member is in the same contents as those described above. Meanwhile, since the covering body in the first aspect includes at least the above described conductive member, the first member and the second member may be respectively configured by a material not including conductivity. Examples of the material not including conductivity may include a resin such as a thermoplastic resin and a rubber. Also, the shape of the first member and the second member is not particularly limited, but for example it is a flat plate shape.

### (2) Second Aspect

The covering body in the second aspect includes a first member, a second member, and a connecting member configured to connect the first member and the second member. Also, at least one of the first member and the second member is a conductive member. Also, in the soaking step, the first member and the second member are faced to each other interposing the Al terminal, and a relative position of the first member and the second member is fixed by the connecting member, so that the covering body is arranged on the Al terminal.

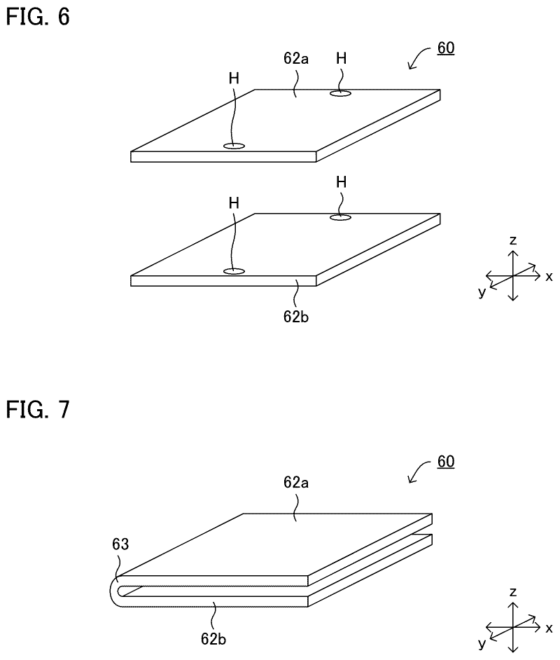

FIG. 6 is a schematic side view exemplifying the covering body in the present disclosure. Incidentally, for convenience, the description of the connecting member is omitted in FIG. 6. Covering body 60 shown in FIG. 6 includes first member 62a and second member 62b. At least one of the first member 62a and the second member 62b is a conductive member. The materials and the shapes of the first member 62a and the second member 62b are in the same contents as those described in the first aspect above. Also, when the first member 62a is a metal member, the first member 62a may include a conductive resin part, and may include a plated part, on the Al terminal side surface. Similarly, when the second member 62b is a metal member, the second member 62b may include a conductive resin part, and may include a plated part, on the Al terminal side surface. The conductive resin part and the plated part are in the same contents as those described in the first aspect above.

The first member may be electrically connected to the Al terminal in the soaking step. In the soaking step, the first member is, to the main surface of the Al terminal, preferably directly in surface-contact, or in surface-contact interposing another layer. Similarly, the second member may be electrically connected to the Al terminal in the soaking step. In the soaking step, the second member is, to the main surface of the Al terminal, preferably directly in surface-contact, or in surface-contact interposing another layer.

As shown in FIGS. 4A and 4B, the first member 62a and the second member 62b may include hole part H for inserting the connecting member 63. As shown in FIG. 4B, by fixing the relative position of the first member 62a and the second member 62b by the connecting member 63, the covering body 60 is arranged on the Al terminal 30X. Also, the connecting member 63 shown in FIG. 4B includes rod shape member 63a, and fixing member 63b connected to the rod shape member 63a and including a fixing structure such as a screw structure. Meanwhile, as shown in FIG. 7, the connecting member 63 may be a member including a bending structure. In FIG. 7, the first member 62a, the second member 62b and the connecting member 63 are one body.

### (3) Third Aspect

The covering body in the third aspect is a hollow member including a space part. Also, the hollow member is a conductive member. Also, in the soaking step, the Al terminal is inserted to the space part so as to arrange the covering body on the Al terminal.

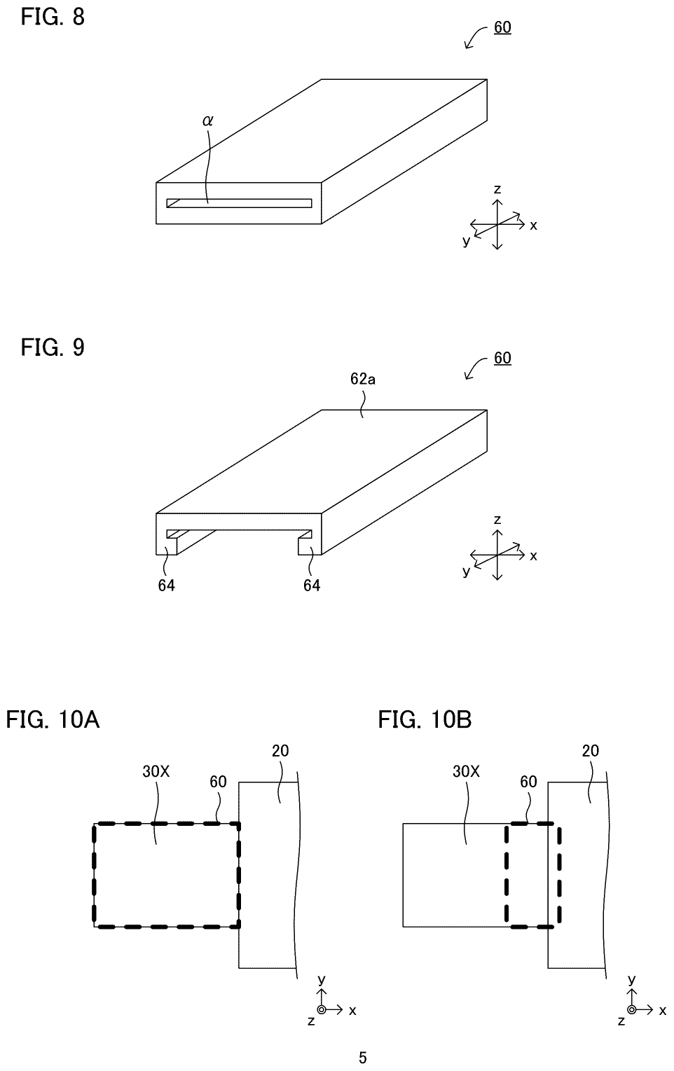

FIG. 8 is a schematic perspective view exemplifying the covering body in the present disclosure. The covering body 60 shown in FIG. 8 is a hollow member including a space part x. An Al terminal (not illustrated) is inserted to the space part x. The hollow member is a conductive member. The material of the conductive member is in the same contents as those described in the first aspect above.

When the hollow member is a metal member, the hollow member may include, on the Al terminal side surface, a conductive resin part, and may include a plated part. The conductive resin part and the plated part are in the same contents as those described in the first aspect above. Also, the hollow member is electrically connected to the Al terminal in the soaking step. In the soaking step, the hollow member is, to the main surface of the Al terminal, preferably directly in surface-contact, or in surface-contact interposing another layer.

### (4) Fourth Aspect

The covering body in the fourth aspect includes a first member, and a pair of nail member arranged in each of a pair of side of the first member facing to each other. Also, at least one of the first member and the nail member is a conductive member. Also, in the soaking step, the Al terminal is fixed by the pair of nail member so that the covering body is arranged on the Al terminal.

FIG. 9 is a schematic perspective view exemplifying the covering body in the present disclosure. The covering body 60 shown in FIG. 9 includes first member 62a, and a pair of nail member 64 arranged in each of a pair of side of the first member 62a facing to each other. An Al terminal (not illustrated) is fixed by the pair of nail member 64. Also, at least one of the first member 62a and the nail member 64 is a conductive member. The material of the conductive member is in the same contents as those described in the first aspect above. Also, when the first member 62a is a metal member, the first member 62a may include a conductive resin part, and may include a plated part, on the Al terminal side surface. Similarly, when the nail member 64 is a metal member, the nail member 64 may include, on the Al terminal side surface, a conductive resin part, and may include a plated part. The conductive resin part and the plated part are in the same contents as those described in the first aspect above.

The first member may be electrically connected to the Al terminal in the soaking step. In the soaking step, the first member is, to the main surface of the Al terminal, preferably directly in surface-contact, or in surface-contact interposing another layer. Similarly, the nail member may be electrically connected to the Al terminal in the soaking step. In the soaking step, the nail member is, to the Al terminal side surface, preferably directly in contact, or in contact interposing another layer.

### (5) Covering Body

As shown in FIG. 10A, when observed from the thickness direction (z direction), the covering body 60 may be arranged to cover the Al terminal 30X entirely. Meanwhile, as shown in FIG. 10B, when observed from the thickness direction (z direction), the covering body 60 may be arranged to cover the Al terminal 30X partially. In FIG. 10B, the covering body 60 is arranged to cover selectively in a region including an end part of the outer package 20 side of the Al terminal 30X. By protecting the region (root region) including the end part of the outer package 20 side of the Al terminal 30X, when the battery is soaked in the treatment liquid, the outer short circuit can be further maintained, and the battery may be deactivated further well. Also, “the covering body is arranged to cover selectively in a region including an end part of the outer package side of the Al terminal” means that there is a region where the covering body 60 is not arranged in the opposite side to the outer package 20 side of the root region as shown in FIG. 10B. Also, from the thickness direction, when Sa designates an area of the Al terminal, and Sp designates an area of a region where the Al terminal overlaps with the conductive member in the covering body, the rate of the area Sb with respect to the area Sa, which is Sb/Sa is not particularly limited, but for example, it is 10% or more, may be 30% or more, may be 50% or more, and may be 70% or more.

### 2. Battery

As shown in FIGS. 1A and 1B, the battery 100 usually includes the electrode body 10, the outer package 20 covering the electrode body 10, and the terminal 30 (30A, 30B) that is electrically connected to the electrode body 10, and is partially exposed from the outer package 20. Also, at least one of the terminal 30A and the terminal 30B is an Al terminal. In FIGS. 1A and 1B, the terminal 30A corresponds to Al terminal 30X.

In the present disclosure, a unit configured by an electrode body, an outer package, and a pair of terminals may be referred to as a “cell”. The battery to be disposed of by the disposing method in the present disclosure may include one cell, and may include a plurality cells. A plurality of cells are usually layered in a thickness direction. Also, in the present disclosure, each of the Al terminal in a plurality of cells layered in the thickness direction may be covered by one covering body all together.

### (1) Terminal

The battery in the present disclosure usually includes a cathode terminal and an anode terminal. At least one of the cathode terminal and the anode terminal is an Al terminal. Among them, at least the cathode terminal is preferably the Al terminal. The Al terminal is a terminal containing at least aluminum. The Al terminal preferably contains aluminum as a main component of the metal component. In the Al terminal, the proportion of the aluminum with respect to all the metal components is, for example, 50 weight % or more, may be 70 weights or more, and may be 90 weight % or more. Examples of the material of the Al terminal may include aluminum and an aluminum alloy.

There are no particular limitations on the shape of the Al terminal. Also, there are no particular limitations on the thickness of the Al terminal either, but the thinner the Al terminal, the greater the influence of the deterioration of the Al terminal by the treatment liquid. The thickness of the Al terminal means the length of the Al terminal in a normal direction of a main surface (surface with the largest area) of the Al terminal. The thickness of the Al terminal is, for example, 2 mm or less, may be 1.5 mm or less, may be 1.0 mm or less, may be 0.8 mm or less, and may be 0.6 mm or less. Meanwhile, the thickness of the Al terminal is, for example, 0.1 mm or more.

### (2) Electrode Body

The electrode body in the present disclosure works as a power generating element of the battery. The electrode body usually includes layers in an order of, a cathode current collector, a cathode active material layer, an electrolyte layer, an anode active material layer, and an anode current collector, in a thickness direction.

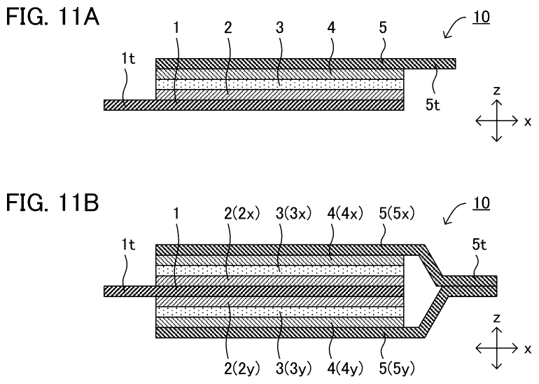

FIGS. 11A and 11B are schematic cross-sectional views exemplifying the electrode body in the present disclosure. Electrode body 10 shown in FIG. 11A includes layers in an order of, anode current collector 1, anode active material layer 2, electrolyte layer 3, cathode active material layer 4 and cathode current collector 5, in a thickness direction (z direction). Also, the anode current collector 1 includes anode tab 1t configured to connect to an anode terminal (not illustrated), and the cathode current collector 5 includes cathode tab 5t configured to connect to a cathode terminal (not illustrated).

The electrode body 10 illustrated in FIG. 11B includes, anode current collector 1, and layers arranged in the order in the thickness direction (z direction) from one surface of the anode current collector 1, that are anode active material layer 2x, electrolyte layer 3x, cathode active material layer 4x and cathode current collector 5x, and layers arranged in the order in the thickness direction (z direction) from the other surface of the anode current collector 1, that are anode active material layer 2y, electrolyte layer 3y, cathode active material layer 4y and cathode current collector 5y.

In FIGS. 11A and 11B, the cathode tab 5t and the anode tab 1t are arranged so as to face to each other in the side surface of the electrode body 10 to form a so-called double-tab structure. Meanwhile, although not illustrated in particular, the cathode tab and the anode tab may be arranged on the same side surface of the electrode body to form a so-called single-tab structure. Also, as shown in FIGS. 11A and 11B, the electrode body 10 may be in a sheet shape. Also, although not illustrated in particular, the electrode body may be in a winding shape. Also, a unit configured by a cathode active material layer, an electrolyte layer and an anode active material layer may be referred to as a “power generating unit”. The electrode body in the present disclosure may include one of the power generating unit, and may include a plurality of the power generating unit. A plurality of the power generating unit is usually layered in a thickness direction.

The cathode active material layer contains at least a cathode active material. The cathode active material layer may further contain at least one of an electrolyte, a conductive material, and a binder. Examples of the cathode active material may include an oxide active material. Examples of the oxide active material may include a rock salt bed type active material such as LiNi_{1/3}Co_{1/3}Mn_{1/3}O₂, and LiNi_{0.8}Co_{0.15}Al_{0.05}O₂; a spinel type active material such as LiMn₂O₄; and an olivine type active material such as LiFePO₄. Examples of the shape of the cathode active material may include a granular shape.

The electrolyte may be a solid electrolyte and may be an electrolyte solution (liquid electrolyte). The solid electrolyte may be an organic solid electrolyte such as a gel electrolyte, and may be an inorganic solid electrolyte such as a sulfide solid electrolyte and an oxide solid electrolyte. Among those, the solid electrolyte is preferably a sulfide solid electrolyte. The reason therefor is its high ion conductivity. Meanwhile, there are no particular limitations on the electrolyte solution, and known electrolytes may be used. Also, examples of the conductive material may include a carbon material. Also, examples of the binder may include a rubber-based binder and a fluoride-based binder.

The anode active material layer contains at least an anode active material. The anode active material layer may further contain at least one of an electrolyte, a conductive material, and a binder. Examples of the anode active material may include a metal active material such as Li, Si and Sn, a carbon active material such as graphite, and an oxide active material such as Li₄Ti₅O₁₂.

The electrolyte layer is arranged between the cathode active material layer and the anode active material layer, and contains at least an electrolyte. The electrolyte may be a solid electrolyte and may be an electrolyte solution. The electrolyte is in the same contents as those described above. The electrolyte layer may be a solid electrolyte layer containing a solid electrolyte. Further, the solid electrolyte is preferably a sulfide solid electrolyte. Also, in general, a battery including the electrolyte layer containing an inorganic solid electrolyte is called a solid state battery. The solid state battery may be a semisolid state battery and may be an all solid state battery. In the present disclosure, the semisolid state battery is a battery in which the electrolyte layer includes an inorganic solid electrolyte and a liquid component (such as ionic solution). In the present disclosure, the all solid state battery is a battery in which the electrolyte layer includes only the inorganic solid electrolyte as the electrolyte.

The cathode current collector collects currents of the cathode active material layer. Examples of the material for the cathode current collector may include a metal such as aluminum, SUS, and nickel. Examples of the shape of the cathode current collector may include a foil shape. The cathode current collector usually includes a cathode tab configured to connect to the cathode terminal. Also, the anode current collector collects currents of the anode active material layer. Examples of the material for the anode current collector may include a metal such as copper, SUS, and nickel. Examples of the shape of the anode current collector may include a foil shape. The anode current collector usually includes an anode tab configured to connect to the anode terminal.

### (3) Outer Package

The outer package in the present disclosure may be a laminate type outer package, and may be a case type outer package. The laminate type outer package is also called a pouch type outer package, and is an outer package using a laminate film. The laminate type outer package includes at least an inner side resin layer and a metal layer. The inner side resin layer works as a sealant layer. The inner side resin layer preferably contains a thermoplastic resin. Examples of the thermoplastic resin may include polyolefin such as polyethylene and polypropylene; polystyrene; and polyvinyl chloride. The thickness of the inner side resin layer is not particularly limited, and for example, it is 30 μm or more and 150 μm or less.

The metal layer works as a barrier layer. Examples of the metal used in the metal layer may include aluminum, an aluminum alloy, and stainless steel. The thickness of the metal layer is not particularly limited, and for example, it is 20 μm or more and 100 μm or less. Also, the laminate type outer package may include an outer side resin layer in the opposite side to the inner side resin layer on the basis of the metal layer. The outer side resin layer works as an insulating layer or a protective layer. The outer side resin layer preferably contains a thermoplastic resin. Examples of the thermoplastic resin may include polyester such as polyethylene terephthalate (PET); and nylon. The thickness of the outer side resin layer is not particularly limited, and for example, it is 20 μm or more and 100 μm or less.

The case type outer package is, for example, an outer package made of metal. Examples of the material configuring the case type outer package may include a metal aluminum and an aluminum alloy. Also, a plastic processing may be performed to aluminum or an aluminum alloy, and the material processed and cured may be used. Also, the thickness of the case type outer package is not particularly limited, and selected to the extent the desired rigidity can be obtained.

### (4) Battery

Examples of the battery in the present disclosure may include a secondary battery such as a lithium ion secondary battery. Also, examples of the applications of the battery before performing the disposing method in the present disclosure may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably a battery that was used as a power source for driving hybrid electric vehicles (HEV), plug-in hybrid electric vehicles (PHEV), and battery electric vehicles (BEV). It may be a battery that was used as a power source for moving bodies other than vehicles (such as rail road transportation, vessel and airplane), and may be a battery that was used as a power source for electronic products such as information processing equipment.

### 3. Treatment Liquid

The treatment liquid in the present disclosure contains water and a supporting salt.

The supporting salt is used to improve the conductivity of the treatment liquid. Also, the supporting salt usually does not include a function to prevent the Al terminal from eluting. The supporting salt includes a cation component and an anion component. Examples of the cation component of the supporting salt may include an alkali metal ion such as Na and K; and an alkali earth metal ion such as Mg and Ca. Meanwhile, examples of the anion component of the supporting salt may include a chloride ion. Specific examples of the treatment liquid may include NaCl, KCl, MgCl₂, and CaCl₂). Also, the treatment liquid may contain just one kind of the supporting salt, and may contain two kinds or more of the supporting salt.

At least a part of the supporting salt is dissolved in water. The concentration of the supporting salt in the treatment liquid is not particularly limited, but for example, it is 0.01 mol/kg or more and 5.0 mol/kg or less, and may be 0.1 mol/kg or more and 3.0 mol/kg or less. In the present disclosure, the concentration of the supporting salt is defined as a ratio of number of moles of the supporting salt with respect to the weight of water included present disclosure treatment liquid. Also, examples of the method for preparing the treatment liquid may include a method in which the supporting salt is dissolved in water.

### 4. Soaking Step

In the soaking step of in the present disclosure, a battery including an Al terminal is soaked present disclosure treatment liquid to decrease a voltage of the battery by causing outer short circuit through the treatment liquid. In specific, as shown in FIG. 2, treatment liquid 50 is put in treating bath 40, and battery 100 is soaked in the treatment liquid 50.

There are no particular limitations on the temperature of the treatment liquid in the soaking step. For example, since the freezing point of salt water is about −20° C., the temperature of the treatment liquid is preferably −20° C. or more, and more preferably 0° C. or more. Meanwhile, the temperature of the treatment liquid is, for example, 60° C. or less and may be 40° C. or less. Also, the temperature of the treatment liquid in the soaking step may be the same as the room temperature.

There are no particular limitations on the treatment time in the soaking step, but from the view point of workability, for example, it is preferably 1 hour or more and 50 hours or less, and more preferably 2 hours or more and 25 hours or less.

### B. Covering Body

The covering body in the present disclosure is a covering body to be used in the above described method for disposing of battery, and corresponds to any one of (i) to (iv) as follows:
(i) the covering body includes a conductive member;
(ii) the covering body includes a first member, a second member, and a connecting member configured to connect the first member and the second member, and at least one of the first member and the second member is a conductive member;
(iii) the covering body is a hollow member including a space part, and the hollow member is a conductive member;
(iv) the covering body includes a first member, and a pair of nail member arranged in each of a pair of side of the first member facing to each other, and at least one of the first member and the nail member is a conductive member.

According to the present disclosure, by using the above described covering body, a battery can be deactivated well. Details of the covering body are in the same contents as those described in “A. Method for disposing of battery” above; thus, the descriptions herein are omitted.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Comparative Example 1

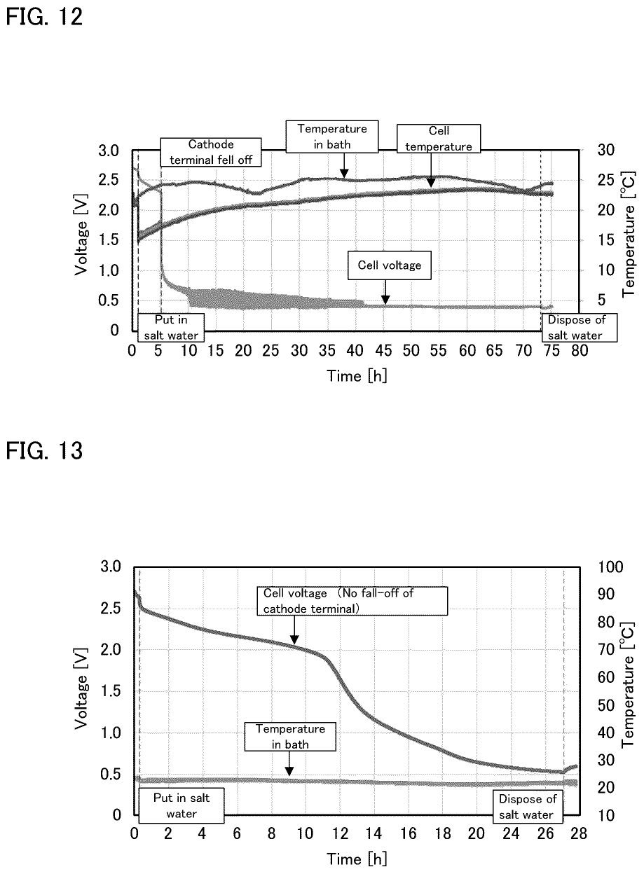

A laminate cell including Al terminal (0.4 mm thick) as the cathode terminal and the anode terminal was prepared. The laminate cell was fully charged, a terminal for voltage measurement was respectively installed to the cathode terminal and the anode terminal, and arranged in a treating bath. After that, to the treating bath, salt water having the concentration of 3.5 weight % was put in, the laminate cell was soaked therein, and the change of the cell voltage, the cell temperature, and the temperature in the bath were monitored. The results are shown in FIG. 12.

As shown in FIG. 12, sharp drop of the voltage was confirmed in 5 hours from putting in salt water. In specific, the voltage sharply dropped from about 2.3 V until about 0.5 V. Meanwhile, after 72 hours passed, when the state of the cathode terminal and the anode terminal was visually observed, it was confirmed that the cathode terminal fell off. Also, after 72 hours passed, when the cell voltage was measured through the cathode terminal remained in the cell side, the remaining voltage was not about 0.5 V, but was about 2.2 V. Meanwhile, dramatic change was not confirmed in the cell temperature and the temperature in the bath.

### Example 1

A laminate cell including Al terminal (0.4 mm thick) as the cathode terminal and the anode terminal was prepared. Next, as shown in FIGS. 5A and 5B, two pieces of conductive members 61a and 62b were arranged on both surfaces of the Al terminal 30X. An Al plate (3 mm thick) was used as a conductive member, and two pieces of the conductive member was arranged to cover the Al terminal entirely when viewed from the thickness direction. The laminate cell was fully charged, a terminal for voltage measurement was respectively installed to the cathode terminal and the anode terminal, and arranged in a treating bath. After that, to the treating bath, salt water having the concentration of 3.5 weight % was put in, the laminate cell was soaked therein, and the change of the cell voltage and the temperature in the bath were monitored. The results are shown in FIG. 13.

As shown in FIG. 13, in 11 hours from putting in salt water, large drop of the voltage was confirmed. In specific, the voltage dropped from about 1.9 V until about 1.2 V. Meanwhile, after 25 hours passed, when the state of the cathode terminal and the anode terminal was visually observed, it was confirmed that neither the cathode terminal nor the anode terminal fell off. Also, after 25 hours passed, when the cell voltage was measured, the remaining voltage was about 0.5 V. Meanwhile, dramatic change in the temperature in the bath was not confirmed.

In this manner, it was confirmed that the battery was deactivated well by using the covering body including conductivity.

### REFERENCE SINGS LIST

1 anode current collector
2 anode active material layer
3 electrolyte layer
4 cathode active material layer
5 cathode current collector
10 electrode body
20 outer package
30 terminal
40 treating bath
50 treatment liquid
60 covering body
100 battery

What is claimed is:

1. A method for disposing of a battery, the method comprising:
a soaking step of soaking a battery including an Al terminal in a treatment liquid to decrease a voltage of the battery by causing outer short circuit through the treatment liquid, wherein
the treatment liquid contains water and a supporting salt; and
in the soaking step, a covering body including conductivity is used, and the covering body is arranged so as to cover at least a part of the Al terminal to make the treatment liquid and the Al terminal electrically connected through the covering body.

2. The method for disposing of a battery according to claim 1, wherein
the covering body includes a conductive member; and
in the soaking step, the covering body is arranged on the Al terminal so as to electrically connect the conductive member and the Al terminal.

3. The method for disposing of a battery according to claim 2, wherein the conductive member is a metal member.

4. The method for disposing of a battery according to claim 3, wherein a material of the metal member is an aluminum or an aluminum alloy.

5. The method for disposing of a battery according to claim 3, wherein a material of the metal member is an iron or an iron alloy.

6. The method for disposing of a battery according to claim 3, wherein a material of the metal member is a magnesium, a magnesium alloy, a zinc, or a zinc alloy.

7. The method for disposing of a battery according to claim 3, wherein the metal member includes a conductive resin part on the Al terminal side surface.

8. The method for disposing of a battery according to claim 3, wherein the metal member includes a plated part on the Al terminal side surface.

9. The method for disposing of a battery according to claim 2, wherein
the covering body further includes a first member, a second member, and a connecting member configured to connect the first member and the second member; and
in the soaking step, the first member and the second member are faced to each other interposing the Al terminal, and a relative position of the first member and the second member is fixed by the connecting member, so that the covering body is arranged on the Al terminal, and the conductive member is arranged between the first member and the Al terminal.

10. The method for disposing of a battery according to claim 1, wherein
the covering body includes a first member, a second member, and a connecting member configured to connect the first member and the second member;
at least one of the first member and the second member is a conductive member; and
in the soaking step, the first member and the second member are faced to each other interposing the Al terminal, and a relative position of the first member and the second member is fixed by the connecting member, so that the covering body is arranged on the Al terminal.

11. The method for disposing of a battery according to claim 1, wherein
the covering body is a hollow member including a space part;
the hollow member is a conductive member; and
in the soaking step, the Al terminal is inserted to the space part so as to arrange the covering body on the Al terminal.

12. The method for disposing of a battery according to claim 1, wherein
the covering body includes a first member, and a pair of nail member arranged in each of a pair of side of the first member facing to each other;
at least one of the first member and the nail member is a conductive member; and
in the soaking step, the Al terminal is fixed by the pair of nail member so that the covering body is arranged on the Al terminal.

13. The method for disposing of a battery according to claim 1, wherein
the battery includes an electrode body, an outer package covering the electrode body, and the Al terminal that is electrically connected to the electrode body, and is partially exposed from the outer package; and
in the soaking step, the covering body is arranged so as to cover at least a boundary of the Al terminal and the outer package.

14. The method for disposing of a battery according to claim 1, wherein the battery includes a laminate type outer package.

15. The method for disposing of a battery according to claim 1, wherein the battery is a solid state battery.

16. A covering body to be used for the method for disposing of a battery according to claim 1, wherein
the covering body corresponds to any one of (i) to (iv) as follows:
(i) the covering body includes a conductive member;
(ii) the covering body includes a first member, a second member, and a connecting member configured to connect the first member and the second member, and at least one of the first member and the second member is a conductive member;
(iii) the covering body is a hollow member including a space part, and the hollow member is a conductive member;
(iv) the covering body includes a first member, and a pair of nail member arranged in each of a pair of side of the first member facing to each other, and at least one of the first member and the nail member is a conductive member.
